(19) United States
(12) Patent Application Publication
(10) Pub. No.: US 2005/0114905 A1
(43) Pub. Date: May 26, 2005

(54) Digital broadcast signal processing system and method capable of receiving multiple digital broadcast signals

(76) Inventor: Min-suk Song, Yongin-si (KR)

Correspondence Address: STANZIONE & KIM, LLP, 1740 N STREET, N.W., FIRST FLOOR, WASHINGTON, DC, 20036, US

(21) Appl. No.: 10/975,084

(22) Filed: Oct. 28, 2004

(30) Foreign Application Priority Data
Nov. 24, 2003 (KR) 2003-83680

(51) Int. Cl. H04N 7/173; H04N 7/16

(52) U.S. Cl. 725/132; 725/100; 725/151; 725/152

(57) ABSTRACT

A digital broadcast signal processing system capable of processing digital broadcast signals according to diverse standards. The system includes a digital broadcast signal receiver that receives at least one or more digital broadcast signals, removes signal characteristics according to standards applied to transmission and reception of the digital broadcast signals, receives a broadcast request signal, and transmits a digital broadcast signal from which the signal characteristics according to a transmission and reception standard have been removed corresponding to the broadcast request signal and middleware for processing the digital broadcast signal from which the signal characteristics according to the corresponding transmission and reception standard have been removed, and at least one digital broadcast signal indicator that transmits the broadcast request signal inputted by a user to the digital broadcast signal receiver, receives from the digital broadcast signal receiver the middleware and the digital broadcast signal from which the signal characteristics according to the transmission and reception standard have been removed, and processes the digital broadcast signal according to the middleware. Accordingly, the system can overcome limitations caused by the digital broadcast signal standards and locations for viewing.

### CROSS-REFERENCE TO RELATED APPLICATIONS

This application claims benefit under 35 U.S.C. § 119 from Korean Patent Application No. 2003-83680, filed on Nov. 24, 2003, the entire content of which is incorporated herein in its entirety.

### BACKGROUND OF THE INVENTION

1. Field of the Invention

The present general inventive concept relates to a digital broadcast signal processing system and method capable of receiving multiple digital broadcast signals, and more particularly, to a digital broadcast signal processing system and method capable of facilitating diverse digital broadcasts and receiving multiple digital broadcast signals enabling users to view digital broadcasts at low expense by separately processing a signal portion to be processed according to a signal transmission and reception standard and a signal portion applicable in common in processing the digital broadcast signal.

2. Description of the Related Art

Recently, with broadcast technologies developments and users' demands, ground wave digital broadcasts have started being serviced, and satellite broadcasts and cable broadcasts are coming into the public. However, basically, different standards are applied to the ground wave digital broadcast signals, satellite digital broadcast signals, and cable digital broadcast signals, as well as broadcast service providers providing the digital broadcast signals of their own where different standards have been applied. Therefore, devices for viewing the ground wave broadcasts, satellite broadcasts or cable broadcasts are manufactured to comply with the standards for the digital broadcast signals transmitted by respective broadcast service providers, and users have to be equipped with extra devices for receiving broadcast signals to view the broadcasts.

FIG. 1A to FIG. 1C are block diagrams for showing the conventional ground wave digital broadcast signal receiver, satellite broadcast receiver, and cable broadcast receiver, respectively.

Referring to FIG. 1A to FIG. 1C, the ground wave digital broadcast signal processing system 10 shown in FIG. 1A has a ground wave tuner 11, a ground wave channel decoder 12, a demultiplexer 13, a video decoder 14, an audio decoder 15, an additional data storage unit 16, and a central processing unit (CPU) 17.

In FIG. 1A, the ground wave tuner 11 tunes a channel in ground wave frequency bands, and receives a ground wave digital broadcast signal. The ground wave channel decoder 12 demodulates the digital broadcast signal corresponding to a modulation mode applied when the signal is transmitted, and decodes the digital broadcast signal in a tuned channel corresponding to a channel coding mode applied when the ground wave digital broadcast signal is transmitted.

The demultiplexer 13 separates the channel-decoded ground wave digital broadcast signal into a video signal, an audio signal, and a data signal. The video decoder 14 decodes the separated video signal, and the audio decoder 15 decodes the separated audio signal. Further, the separated additional data is stored in the additional data storage unit 16, decoded in the CPU 17, and processed in a manner suitable for the additional data. The CPU 17 runs the ground wave broadcast signal processing middleware to control a series of ground wave broadcast signal processing operations as described above.

FIG. 1B is a block diagram for showing a satellite broadcast signal receiver 20, which includes a satellite broadcast signal tuner 21, a satellite broadcast channel decoder 22, a satellite broadcast conditional access system (CAS) 23, a demultiplexer 24, a video decoder 25, an audio decoder 26, an additional data storage unit 27, and a CPU 28.

The satellite broadcast signal tuner 21 tunes a channel in the frequency bands used for the satellite broadcasts, and receives a digital broadcast signal. The satellite broadcast channel decoder 22 demodulates and decodes the digital broadcast signal corresponding to manners in which the satellite digital broadcast signal has been modulated and coded. In pay satellite broadcast services, the satellite broadcast CAS 23 is for giving choices to a broadcast receiver, which reads a key value for descrambling from a CAS card provided and installed by a broadcast service provider when subscribed to satellite broadcast signal receptions, and descrambles a scrambled video signal.

The same descriptions as in FIG. 1A are applied to the operations of the demultiplexer 24, video decoder 25, audio decoder 26, and additional data storage unit 27, and the CPU 28 runs the satellite broadcast signal processing middleware to control a series of operations according to a satellite broadcast signal process.

FIG. 1C is a block diagram for showing a cable broadcast signal receiver 30, which includes a cable broadcast tuner 31, a cable broadcast channel decoder 32, a cable broadcast conditional access system (CAS) 33, a demultiplexer 34, a video decoder 35, an audio decoder 36, an additional data recorder 37, and a CPU 38.

The cable broadcast tuner 31 tunes a channel in the frequency bands used for cable broadcasts, and receives a cable digital broadcast signal. The cable broadcast channel decoder 32 demodulates and decodes the digital broadcast signal corresponding to the manners in which the cable digital broadcast signal has been modulated and coded.

The operations of the cable broadcast CAS 33, demultiplexer 34, video decoder 35, audio decoder 36, and additional data storage unit 37 are the same as described in FIG. 1B, and the CPU 38 runs the cable broadcast signal processing middleware to control a series of cable broadcast signal processing operations described as above.

As stated above, the ground wave digital broadcast signal receiver 10, satellite broadcast signal receiver 20, and cable broadcast signal receiver 30 have the CAS's 23 and 33, demultiplexers 13, 24, and 34, video decoders 14, 25, and 35, audio decoders 15, 26, and 36, and additional data storage units 16, 27, and 37, which are the same in structure but driven by different middleware, in addition to the tuners 11, 21, 31 and channel decoders 12, 22, and 32 which are different in structure according to the different standards for broadcast signal transmissions and receptions.

Therefore, it causes a problem of wasting resources and budgets to have all the above components in order to receive two or more of the above broadcast signals.

Further, in the conventional broadcast signal receptions, broadcasts can be enjoyed only when the broadcast signal receivers and a display device are provided in the same location, which causes a problem that a user has to have a few identical devices at home in some circumstances.

Thus, the conventional system brings about the waste of resources due to the different standards for broadcast signals as well as the waste of resources caused by location restrictions, which causes a problem that broadcast service providers have to put more expenditure on devices to be provided to consumers and the consumers subscribed to broadcast services pay more fees for broadcast signal subscriptions due to the increase of costs in providing broadcasts as well as may pay a double broadcast subscription fee caused by the location restrictions.

### SUMMARY OF THE INVENTION

The present general inventive concept has been developed in order to solve the above drawbacks and other problems associated with the conventional arrangement. An aspect of the present general inventive concept is to provide digital broadcast signal processing system and method capable of not only overcoming limitations to viewing of digital broadcasts due to broadcast signal transmission and reception standards by externally processing and transmitting received digital broadcast signals that have to be processed in compliance with the digital broadcast signal transmission and reception standards, but also reducing digital broadcast service costs, facilitating functional expansion to receive new digital broadcast services, facilitating maintenance and management, and receiving plural digital broadcast signals by overcoming location restrictions as to placing the digital broadcast signal processing system, such as a conventional settop box.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are substantially realized by providing a digital broadcast signal processing system including a digital broadcast signal receiver that receives at least one or more digital broadcast signals, removes signal characteristics according to standards applied to transmission and reception of the digital broadcast signals, receives a broadcast request signal, and transmits a digital broadcast signal from which the signal characteristics according to a transmission and reception standard have been removed corresponding to the broadcast request signal and middleware for processing the digital broadcast signal from which the signal characteristics according to the corresponding transmission and reception standard have been removed, and at least one digital broadcast signal indicator that transmits the broadcast request signal inputted by a user to the digital broadcast signal receiver, receives from the digital broadcast signal receiver the middleware and the digital broadcast signal from which the signal characteristics according to the transmission and reception standard have been removed, and processes the digital broadcast signal according to the middleware.

The digital broadcast signal receiver may include unit connectors to detachably connect at least one or more digital broadcast signal interface units that receive the digital broadcast signals and remove the signal characteristics according to the signal transmission and reception standard with respect to the received digital broadcast signals; a memory that stores the middleware that processes the digital broadcast signal from which the signal characteristics according to the signal transmission and reception standard have been removed corresponding to each of the digital broadcast signals received by the broadcast signal interface units; and a receiver central processing unit (CPU) that controls the transmission of the middleware for a requested digital broadcast signal corresponding to the broadcast request signal and the digital broadcast signal from which the signal characteristics according to the signal transmission and reception standard have been removed from the digital broadcast signal interface unit receiving the requested digital broadcast signal to an external device.

The unit connectors enable more digital broadcast signal interface units to be added, and the memory can store more middleware corresponding to digital broadcast signals that the added digital broadcast signal interface units receive and process as the digital broadcast signal interface units have been added.

Further, the digital broadcast signal interface units may each include a tuner that tunes a channel and receives the digital broadcast signal; a channel decoder that performs demodulation and channel decoding with respect to the received digital broadcast signal according to a signal transmission and reception standard applied to the received digital broadcast signal, and removes the signal characteristics according to the signal transmission and reception standard; and a unit interface that provides interfacing to receive the digital request signal and transmit the middleware and the digital broadcast signal from which the signal characteristics according to the signal transmission and reception standard have been removed by demodulation and channel decoding under the controls of the receiver CPU.

In the meantime, the digital broadcast signal indicator may include an interface unit that receives the digital broadcast signal from which the signal characteristics according to the signal transmission and reception standard for digital broadcast signal services have been removed, and the middleware that processes the digital broadcast signal from which the signal characteristics have been removed; a demultiplexer that separates the received digital broadcast signal into a video signal, audio signal, and additional data; one or more decoders that decode the separated video signal and audio signal; and an indicator CPU that controls the demultiplexer and the decoders according to the received middleware.

An additional data storage unit may further be included to store the additional data, and the indicator CPU can decode the additional data, perform processing of the decoded additional data according to the middleware, and add the processed additional data to the video signal or the audio signal. It is an aspect to further include a middleware storage unit that stores the middleware received from the digital broadcast signal receiver.

On the other hand, the middleware for the present system may include a function of descrambling signals corresponding to a scrambling manner for the digital broadcast signal, and the digital broadcast signal indicator may further include a Conditional Access System (CAS) performing descrambling corresponding to the scrambling manner for the received digital broadcast signal, and may operate according to the execution of the middleware that includes the function capable of performing descrambling. In general, the CAS may perform the descrambling by reading a key value out of a card that has the key value enabling the scrambling, and the present general inventive concept enables the cards to be added corresponding to digital broadcast signals so that the descrambling can be performed with respect to the plural digital broadcast signals.

The middleware may be developed by use of the broadcast signal processing Application Program Interface (API), and the broadcast signal processing API may include a set of functions that define operations and control the defined operations to process the digital broadcast signal in the digital broadcast signal indicator. In other words, the broadcast signal processing API provides functions that define operations and control the defined operations with respect to respective devices such as the demultiplexer, decoders, and CAS of the digital broadcast signal indicator, and the broadcast providers who provide broadcast services use the broadcast signal processing API so that the digital broadcast signal indicator processes the standards for broadcast signals they transmit. The middleware may be developed in the JAVA programming language as a mobile programming language.

As the decoders each decoding the video signal and audio signal, MPEG video decoders can be used to process video signals, and the MPEG audio decoders or Dolby-AC-3 decoders can be used to process audio signals.

The digital broadcast signal indicator may further include a function storage unit that stores the functions that the middleware uses, and the middleware is actually performed by calling the functions stored in the function storage unit.

For the mutual data transmissions, receptions, and communications in the digital broadcast signal indicator according to the present general inventive concept, the digital broadcast signal receiver and the digital broadcast signal indicators constitute a Daisy chain network, and the devices constituting the network can communicate by use of an IEEE 1394 High Speed Data Interface (HSDI).

Further, the digital broadcast signal can be any of a ground wave digital broadcast signal, satellite digital broadcast signal, and cable digital broadcast signal.

As stated above, the digital broadcast signal receiver can perform demodulation and channel decoding to remove signal characteristics according to signal transmission and reception standards, and then the digital broadcast signal indicator receives the demodulated and channel-decoded digital broadcast signal and the corresponding middleware, which enables the present general inventive concept to overcome limitations caused by the broadcast standards with respect to the broadcasts that can be viewed through the digital broadcast signal indicator.

The foregoing and/or other aspects and advantages of the present general inventive concept may also be achieved by providing a digital broadcast signal processing method including a digital broadcast signal receiving operation of receiving at least one or more digital broadcast signals, removing signal characteristics according to standards applied to transmission and reception of the digital broadcast signals, receiving a broadcast request signal, and transmitting a digital broadcast signal from which the signal characteristics according to a signal transmission and reception standard have been removed corresponding to the broadcast request signal and middleware that processes the digital broadcast signal from which the signal characteristics according to the corresponding signal transmission and reception standard have been removed, and a digital broadcast signal indicating operation of transmitting the broadcast request signal inputted by a user, receiving the middleware and the digital broadcast signal from which the signal characteristics according to the signal transmission and reception standard have been removed, and processing the digital broadcast signal according to the middleware.

In an aspect of the above method, the digital broadcast signal receiving operation may include a digital broadcast signal interfacing operation of receiving at least one or more digital broadcast signals and removing the signal characteristics according to the signal transmission and reception standard with respect to the received digital broadcast signals; and an operation of, if a broadcast request signal is received from an external device, transmitting to the external device the digital broadcast signal corresponding to the broadcast request signal from which the signal characteristics according to the signal transmission and reception standard have been removed and middleware that processes the digital broadcast signal from which the signal characteristics have been removed.

The digital broadcast signal interfacing operation may include a tuning operation of tuning a channel for the digital broadcast signal to be received and receiving the digital broadcast signal; and a channel decoding operation of performing demodulation and channel decoding with respect to the received digital broadcast signal according to a signal transmission and reception standard applied to the received digital broadcast signal, and removing the signal characteristics according to the signal transmission and reception standard.

The digital broadcast signal indicating operation may include an operation of transmitting the broadcast request signal, an operation of receiving from the digital broadcast signal receiver the digital broadcast signal from which the signal characteristics according to the signal transmission and reception standard have been removed and the middleware that processes the digital broadcast signal from which the signal characteristics have been removed; an operation of executing the middleware, a demultiplexing operation separating the received digital broadcast signal into a video signal, audio signal, and additional data according to the received middleware; and an operation of video-decoding and audio-decoding the video signal and audio signal separated according to the executed middleware.

The digital broadcast signal indicating method may further include an additional data storage operation of storing the additional data, and an operation of decoding and processing the additional data according to the middleware.

Preferably, the digital broadcast signal indicating method may further include an operation of storing the middleware that processes the digital signal from which the signal characteristics according to the signal transmission and reception standard applied to each of at least one or more digital broadcast signals have been removed, and an operation of transmitting to the external device the middleware corresponding to the requested digital broadcast signal.

In the meantime, the middleware may further include codes of descrambling signals corresponding to a scrambling manner for the digital broadcast signal, and the digital broadcast signal indicating method may further include a Conditional Access System (CAS) operation of performing descrambling corresponding to the scrambling manner for the received digital broadcast signal according to the middleware, and, here, the CAS operation can include an operation of reading a key value out of a card that has the key value enabling the scrambling, and an operation of performing the descrambling by use of the read key value. However, for the digital broadcast signals not scrambled as in ground wave digital signals, the middleware does not include functions for performing the CAS operation.

The middleware may be developed by use of the existing broadcast signal processing Application Program Interface (API), and the broadcast signal processing API may include a set of functions that define operations and controls the defined operations for video processing, audio processing, and data processing in the digital broadcast signal indicator. Further, the functions and the middleware may be developed in the mobile programming language, and, preferably, in the JAVA programming language, and the digital broadcast signal indicating method may further include an operation of storing the functions used by the middleware.

The operation of decoding the video signal and audio signal can use an MPEG video decoder that processes the video signal, and an MPEG audio decoder or a Dolby-AC-3 decoder that processes the audio signal.

The digital broadcast signal can be any of a ground wave digital broadcast signal, satellite digital broadcast signal, and cable digital broadcast signal.

In the meantime, a digital broadcast signal processing system according to the present general inventive concept may include unit connectors that detachably connect digital broadcast signal interface units that receive digital broadcast signals and remove the signal characteristics according to the signal transmission and reception standard with respect to the received digital broadcast signals; a memory that stores middleware that processes the digital broadcast signals from which the signal characteristics according to the signal transmission and reception standard have been removed; and a receiver CPU that controls the transmission of the middleware and the digital broadcast signal from which the signal characteristics according to the signal transmission and reception standard have been removed to a digital broadcast signal indicator.

The digital broadcast signal interface units may each include a tuner that tunes a channel and receiving a digital broadcast signal; a channel decoder that performs demodulation and channel decoding with respect to the received digital broadcast signal according to a signal transmission and reception standard applied to the received digital broadcast signal, and removes the signal characteristics according to the signal transmission and reception standard; and a unit interface that receives a digital request signal and provides interface that transmits the demodulated and channel-decoded digital broadcast signal.

The unit connectors enable more digital broadcast signal interface units to be added, and the memory can store more middleware corresponding to the standards for digital broadcast signals that the added digital broadcast signal interface units receive as the digital broadcast signal interface units have been added.

Further, the middleware may be developed by use of the existing broadcast signal processing Application Program Interface (API), and the broadcast signal processing API may include a set of functions that define operations and control the defined operations for video processing, audio processing, and data processing of the digital broadcast signal from which the signal characteristics according to the signal transmission and reception standard have been removed. The functions and the middleware may be developed in the mobile programming language, preferably, in the JAVA programming language.

Further, the middleware may include the function capable of descrambling corresponding to the scrambling manner for the transmitted digital broadcast signal.

The digital broadcast signal can be any of the ground wave digital broadcast signal, satellite digital broadcast signal, and cable digital broadcast signal.

The foregoing and/or other aspects of the present general inventive concept may also be achieved by providing a digital broadcast signal interface unit including a tuner that tunes a channel for a digital broadcast signal and receives the digital broadcast signal, a channel decoder that performs demodulation and channel decoding with respect to the digital broadcast signal corresponding to the channel coding and modulation manners for the received digital broadcast signal, and a unit interface that provides interface with an external device, and further includes a memory that stores middleware that is a program that processes the digital broadcast signal after the demodulation and channel decoding of the received digital broadcast signal.

Here, the middleware may include the functions capable of descrambling corresponding to the scrambling manner for the digital broadcast signal to be transmitted, and may be developed by use of the existing broadcast signal processing API, and the broadcast signal processing API may include a set of functions that define operations and control the defined operations to process the digital broadcast signal from which the signal characteristics according to the signal transmission and reception standard. The functions and the middleware may be developed in the mobile programming language, preferably, in the JAVA programming language.

Further, the unit interface may be the IEEE 1394 HSDI interface supporting the Daisy chain network, and the digital broadcast signal can be any of the ground wave digital broadcast signal, satellite digital broadcast signal, and cable digital broadcast signal.

A digital broadcast signal interfacing operation according to an embodiment of the present general inventive concept may include a tuning operation of tuning a channel for at least one or more digital broadcast signals and receiving the digital broadcast signal, a channel decoding operation of performing demodulation and channel decoding with respect to the digital broadcast signal corresponding to the channel coding and modulation manners for the received digital broadcast signal, and a unit interfacing operation of providing interface with an external device, and further may include an operation of storing middleware that is a program for processing the digital broadcast signal after the demodulation and channel decoding of the received digital broadcast signal.

In this embodiment, the digital broadcast signal may be any of a ground wave digital broadcast signal, satellite digital broadcast signal, and cable broadcast signal.

A digital broadcast signal indicator according to an embodiment of the present general inventive concept may include an interface unit that receives a digital broadcast signal from which the signal characteristics according to the signal transmission and reception standard have been removed and middleware that processes the digital broadcast signal from which the signal characteristics according to the signal transmission and reception standard have been removed; a demultiplexer that separates the received digital broadcast signal into a video signal, audio signal, and additional data; one or more decoders that decodes the separated video signal and audio signal; and an indicator CPU that controls the demultiplexer and the decoders according to the received middleware.

The digital broadcast signal from which the signal characteristics according to the signal transmission and reception standard have been removed is a digital broadcast signal demodulated and channel-decoded corresponding to channel coding and modulation manners according to the signal transmission and reception standard applied to the digital broadcast signal.

The digital broadcast signal indicator may further include a conditional access system (CAS) that descrambles the digital broadcast signal corresponding to a scrambling manner for the received digital broadcast signal, and the middleware may include functions driving the CAS. Here, the CAS may perform the descrambling by reading a key value out of a card having the key value for performing the descrambling, and more cards can be added corresponding to digital broadcast signals to be received.

Further, the middleware may be developed by use of the existing broadcast signal processing API, and the broadcast signal processing API may include a set of functions that define operations and control the defined operations that process the digital broadcast signal in the broadcast signal indicator. The functions and the middleware are developed in the mobile programming language, preferably, in the JAVA programming language.

The digital broadcast signal indicator may further include a function storage unit that stores the functions provided in the API.

The digital broadcast signal indicator may further include an additional data storage unit that stores the additional data, and the indicator CPU may decode and process the additional data according to the middleware.

An MPEG video decoder can be used to process the video signal, and an MPEG audio decoder or a Dolby-AC-3 decoder can be used to process the audio signal, as the decoders that decode the video and audio signals.

The interface unit may be an IEEE 1394 High Speed Data Interface (HSDI), and the digital broadcast signal can be any of a ground wave digital broadcast signal, satellite digital broadcast signal, and cable digital broadcast signal.

In the meantime, a digital broadcast signal indicating method according to an embodiment of the present general inventive concept may include an operation of receiving a digital broadcast signal from which signal characteristics according to the signal transmission and reception standard for the digital broadcast signal have been removed and middleware that processes the digital broadcast signal from which the signal characteristics according to the signal transmission and reception standard have been removed; a demultiplexing operation of separating the received digital broadcast signal into a video signal, audio signal, and additional data according to the middleware; and a decoding operation of decoding the separated video signal and audio signal according to the middleware.

The digital broadcast signal from which the signal characteristics according to the signal transmission and reception standard have been removed may be a digital broadcast signal demodulated and channel-decoded corresponding to channel coding and modulation manners according to the signal transmission and reception standard applied to the digital broadcast signal.

In an aspect of the present general inventive concept, the digital broadcast signal indicating method may further include a conditional access system (CAS) operation of descrambling the digital broadcast signal corresponding to a scrambling manner for the digital broadcast signal, and the CAS step performs the descrambling by reading a key value out of a card having the key value for performing the descrambling, and more cards can be added corresponding to digital broadcast signals to be received.

Further, the middleware may be developed by use of the existing broadcast signal processing API, and the broadcast signal processing API consists of a set of functions that define operations and control the defined operations of processing the digital broadcast signal in the digital broadcast signal indicator. Here, the functions and the middleware are developed in the mobile programming language, such as, for example, in the JAVA programming language. Further, the digital broadcast signal indicating method may further include a function storage operation of storing the functions provided in API.

The digital broadcast signal indicating method may further include an additional data storage operation of storing additional data, and the additional data is decoded and processed according to the middleware. The digital broadcast signal indicating method may further include a video-encoding operation and an audio digital/analog (D/A)-converting operation of outputting the decoded video and audio signals and the processed additional data.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1A to FIG. 1C are block diagrams showing a conventional ground wave digital broadcast signal receiver, satellite broadcast signal receiver, and cable broadcast signal receiver, respectively;

FIG. 2 is a view schematically showing a digital broadcast signal processing system installed at home according to an embodiment of the present general inventive concept;

FIG. 3 is a flow chart explaining operations of the digital broadcast signal processing system of FIG. 2;

FIG. 4 is a block diagram showing in detail the digital broadcast signal receiver of FIG. 2;

FIG. 5A to FIG. 5C are block diagrams illustrating in detail the digital broadcast signal interface units shown in FIG. 4;

FIG. 6 is a flow chart explaining operations of the digital broadcast signal receiver of FIG. 4;

FIG. 7 is a flow chart explaining in detail the process of FIG. 6 to remove signal characteristics according to signal transmission and reception standards;

FIG. 8 is a block diagram showing in detail the digital broadcast signal indicator of FIG. 2; and

FIG. 9 is a flow chart explaining operations of a digital broadcast signal indicator of FIG. 8.

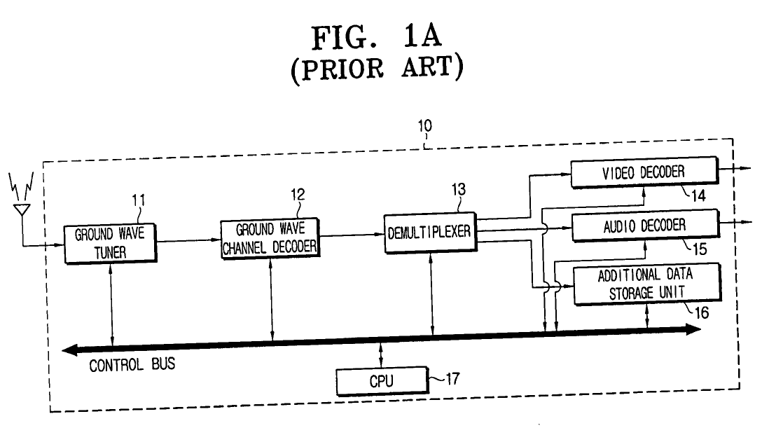

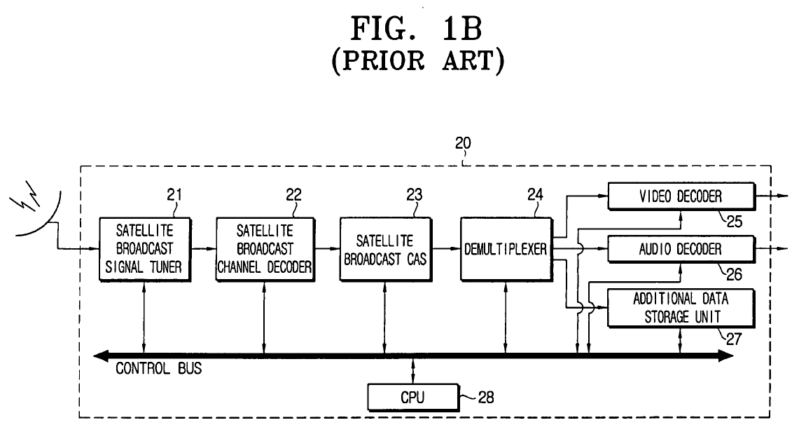

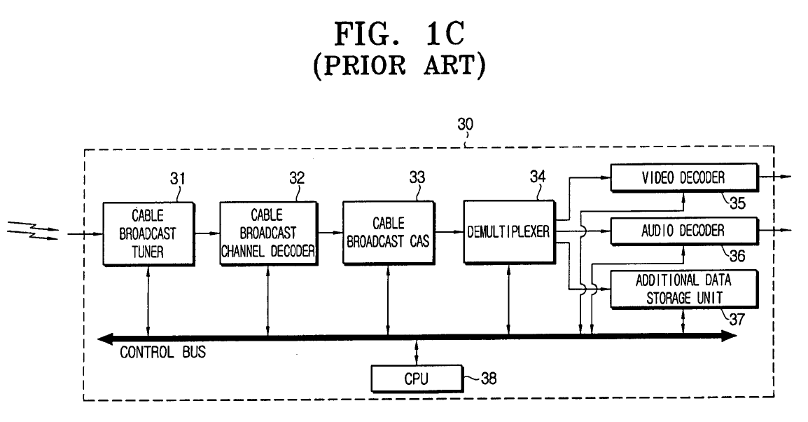

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

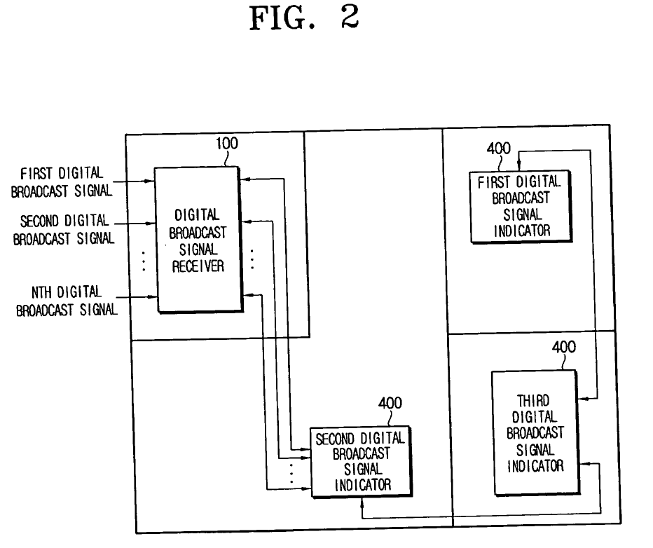

FIG. 2 is a view schematically showing a digital broadcast signal processing system installed at home according to an embodiment of the present general inventive concept. Referring to FIG. 2, this embodiment includes a digital broadcast signal receiver 100 and at least one or more digital broadcast signal indicators 400 that are installed at home.

The digital broadcast signal receiver 100 externally receives various digital broadcast signals such as a ground wave digital broadcast signal, a satellite digital broadcast signal, and a cable digital broadcast signal, removes signal characteristics according to signal transmission and reception standards with respect to a digital broadcast signal corresponding to a broadcast request signal transmitted from one of the digital broadcast signal indicators 400, and transmits a signal characteristics-removed signal to the digital broadcast signal indicator 400. The signal characteristics according to the transmission and reception standards are removed by implementing demodulation and channel decoding corresponding to the channel coding and modulation manners according to the standard applied to the selected broadcast signal. Further, at the same time, the receiver 100 also transmits middleware codes corresponding to the broadcast request signal that forms an application program for descrambling, video processing, audio processing, and data processing in the digital broadcast signal indicator 400 receiving the signal.

The digital broadcast signal indicator 400 sends a broadcast request signal to the digital broadcast signal receiver 100 when there is a user's input on the indicator 400, and receives a digital broadcast signal free of signal characteristics according to the standard for digital broadcast signal transmissions and receptions, that is, demodulated and channel-decoded corresponding to the modulation and channel-coding manners implemented when the signal is transmitted. At the same time, together with the digital broadcast signal, the digital broadcast signal indicator 400 receives middleware for descrambling, video-processing, audio-processing, and additional data processing with respect to a requested digital broadcast signal. Next, the digital broadcast signal indicator 400 runs the received middleware to process the digital broadcast signal, and outputs images and sounds according to the processed digital broadcast signal.

It is possible that the middleware is developed and offered together with broadcast services by broadcast service providers who provide digital broadcast signals. Further, the middleware may be coded by use of broadcast signal processing Application Program Interface (API) consisting of functions enabling the digital broadcast signal indicator 400 to control operations for processing digital broadcast signals. Further, the middleware and functions may be developed in the mobile programming language, and the digital broadcast signal indicator 400 includes an interpreter that interprets the developed middleware and the API functions used in the middleware and is executed based on the interpretations. The mobile programming language may be the JAVA programming language, and a JAVA virtual machine may be used as the interpreter for the middleware developed in the JAVA programming language.

Further, if a broadcast service selected on the digital broadcast signal indicator 400 is a pay broadcast service, the digital broadcast signal indicator 400 receives and descrambles a scrambled digital broadcast signal from the digital broadcast signal receiver 100. If the digital broadcast signal indicator 400 receives a descrambled digital broadcast signal from the digital broadcast signal receiver 100, the expensive 5C cable has to be used as communication lines between the digital broadcast signal receiver 100 and the digital broadcast signal indicator 400, whereas, if the digital broadcast signal indicator 400 performs descrambling, inexpensive communication lines can be used.

In the meantime, the present digital broadcast signal processing system enables communications by use of IEEE1394 high-speed data interface (HDSI), and, if the IEEE 1394 interface is used, the respective digital broadcast signal indicators 400 are connected in a serial network since the IEEE1394 interface supports the daisy chain connection which is a cabling bus system enabling devices to be connected in series for intercommunications, so any of the digital broadcast signal indicators 400 can be connected to the digital broadcast signal receiver 100.

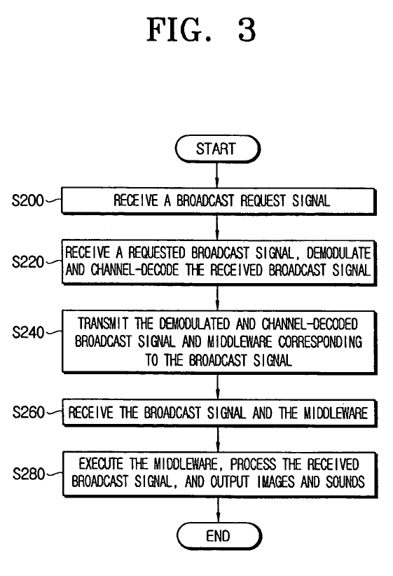

FIG. 3 is a flow chart explaining the operations of the digital broadcast signal processing system shown in FIG. 2. Referring to FIG. 3, the digital broadcast signal indicator 400 transmits a specific broadcast, for example, a broadcast request signal requesting a satellite broadcast for a user to view to the digital broadcast signal receiver 100 (S200). The digital broadcast signal receiver 100 receives the specific broadcast, that is, the satellite broadcast signal, and demodulates and channel-decodes the satellite broadcast signal corresponding to the channel coding and modulation manners before the satellite broadcast signal is transmitted (S220). Further, the digital broadcast signal receiver 100 transmits the satellite broadcast signal, that is, the received broadcast signal, for example, the broadcast signal demodulated and channel-decoded together with satellite broadcast signal processing middleware (S240). Further, the digital broadcast signal indicator 400 receives the middleware and the broadcast signal (S260). Further, the digital broadcast signal indicator 400 runs the received middleware to implement video processing and audio processing with respect to the received broadcast signal, for example, the satellite broadcast signal for outputs of images and sounds (S280).

Through the above system according to FIGS. 2 and 3, broadcast viewers can receive the broadcasts that they want at a low expense and at any places without additional fees.

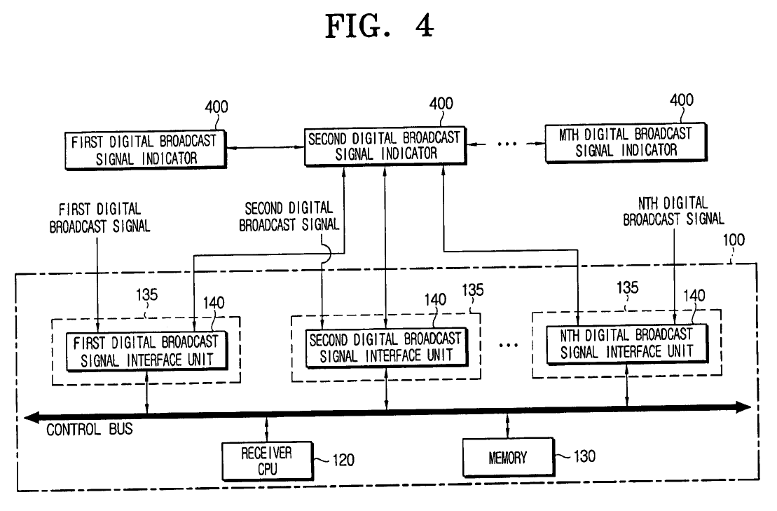

FIG. 4 is a block diagram showing the digital broadcast signal receiver 100 shown in FIG. 2. Referring to FIG. 4, the present digital broadcast signal receiver 100 includes unit connectors 135, a receiver central processing unit (CPU) 120, and a memory 130.

The unit connectors 135 are connected to digital broadcast signal interface units 140 described later as devices that remove signal characteristics according to the standards for broadcast signal transmissions and receptions, and connect the connected digital broadcast signal interface unit with a control bus. The demodulated and channel-decoded signal can be an example of the removal of the signal characteristics according to the signal transmission and reception standard.

The memory 130 stores middleware which is a program for video and audio processing in an external digital broadcast signal indicator with respect to digital broadcast signals received by the respective digital broadcast signal interface units.

The middleware is a program for scrambling, video processing, audio processing, and data processing in the digital broadcast signal indicator 400, developed in the mobile programming language, preferably, the JAVA programming language. Further, the middleware is developed by a provider of the digital broadcast signal interface unit 140, and the middleware is preferably developed by the maker of the digital broadcast signal indicator 400 by use of the Application Program Interface (API) that processes broadcast signals in which functions are defined for operations and operation controls of the digital broadcast signal indicator 400.

Of the digital broadcast signal interface units 140 connected to the unit connectors 135, the receiver CPU 120 controls one digital broadcast signal interface unit 140 receiving a requested broadcast signal so that a broadcast signal whose signal characteristics according to the transmission and reception standard are removed is transmitted to the digital broadcast signal indicator that transmits the broadcast request signal. Further, the receiver CPU 120 controls the memory 130 so as to transmit the broadcast signal together with middleware codes corresponding to the requested broadcast signal.

The digital broadcast signal interface unit 140 can be added and removed, and, in an aspect of the present general inventive concept, as the digital broadcast signal interface unit 140 is added, the middleware for broadcast signals that the added digital broadcast signal interface unit 140 receives is additionally added in the memory 330.

In the meantime, in the communications with the digital broadcast signal indicators, it is possible to use the IEEE1394 HSDI interface, and, in this case, the respective digital broadcast signal indicators 400 constitute a network in series in Daisy chain mode, and a structure is possible that a unit interface included in each of the connected digital broadcast signal interface units 140 is connected to any of the digital broadcast signal indicators 400 connected to the serial network. The unit interface can be the IEEE1394 HSDI interface. With such a structure supporting the Daisy chain mode, the digital broadcast signal indicators constituting a network can communicate with the digital broadcast signal receiver 100 to which a digital broadcast signal interface unit 140 connected to the network is connected.

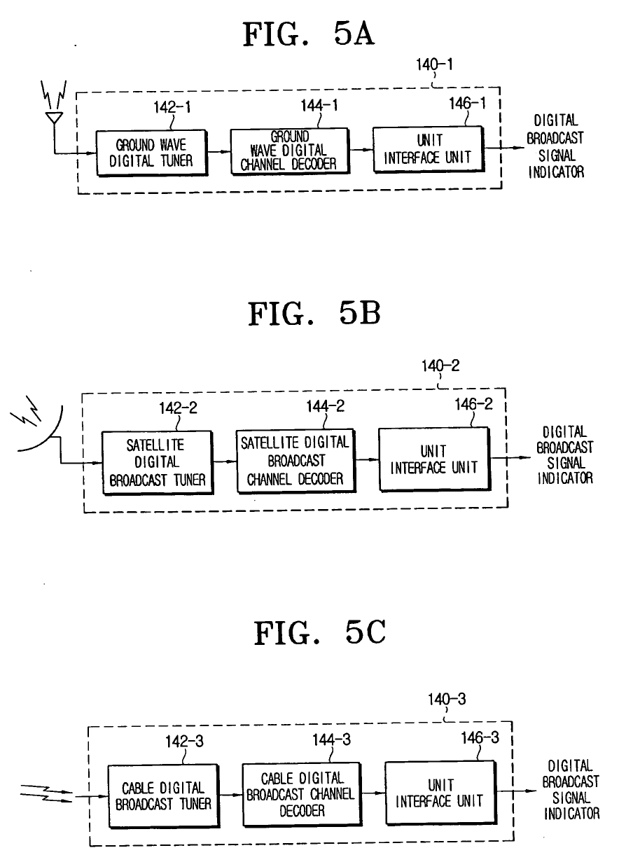

FIG. 5A to FIG. 5C are block diagrams illustrating in detail the digital broadcast signal interface unit 140.

FIG. 5A is a block diagram illustrating the digital broadcast signal interface unit 140 receiving ground wave digital broadcasts. A digital broadcast signal interface unit 140-1 that receives ground wave digital signals includes a ground wave digital signal tuner 142-1 that tunes a channel for a ground wave digital signal and receives the digital broadcast signal, a ground wave digital signal channel decoder 144-1 that performs demodulation and channel-decoding corresponding to the channel-coding and modulation manners for transmitting the received ground wave digital broadcast signal, and a unit interface 146-1 as the IEEE1394 HSDI interface that provides interface with the digital broadcast signal indicators constituting a network.

FIG. 5B is a block diagram illustrating the digital broadcast signal interface unit 140 receiving satellite digital broadcasts. The present digital broadcast signal interface unit 140-2 that receives satellite digital broadcasts includes a satellite digital broadcast tuner 142-1 that tunes a channel for a satellite digital broadcast signal and receives the digital broadcast signal, a satellite digital broadcast channel decoder 144-2 that performs demodulation and channel-decoding corresponding to the channel-coding and modulation manners for transmitting the received satellite digital broadcast signal, and a unit interface 146-2 as the IEEE1394 HSDI interface that provides interface with the digital broadcast signal indicators constructing a network.

FIG. 5C is a block diagram illustrating the digital broadcast signal interface unit 140 receiving cable digital broadcast signals. The digital broadcast signal interface unit 140-3 that receives cable digital broadcast signals includes a cable digital broadcast tuner 142-3 that tunes a channel for a cable digital broadcast signal and receives the cable digital broadcast signal, a cable digital broadcast channel decoder 144-3 that performs demodulation and channel-decoding corresponding to the channel-coding and modulation manners for transmitting the received cable digital broadcast signal, and a unit interface 146-3 as the IEEE1394 HSDI interface that provides interface with the digital broadcast signal indicators constituting a network.

It is possible for each of the digital broadcast signal interface units to further include a memory (not shown) that stores middleware for video processing and audio processing in the digital broadcast signal indicators with respect to the received digital broadcast signal.

With the above structure, the present digital broadcast signal receiver can conveniently receive more digital broadcast signals that a user wants by merely adding the digital broadcast signal interface units to the unit connectors 135 of the digital broadcast signal receiver.

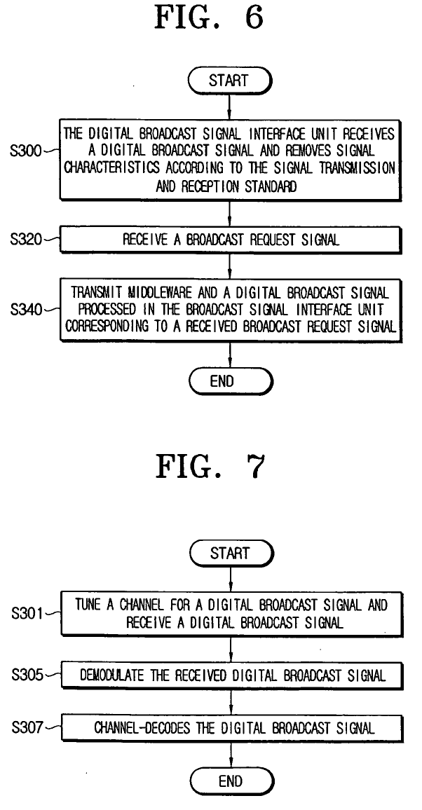

FIG. 6 is a flow chart explaining operations of the digital broadcast signal receiver shown in FIG. 4. Referring to FIG. 4, when the digital broadcast signal receiver 100 is turned on, each of the digital broadcast signal interface units 140 can receive a corresponding digital broadcast signal, and can remove signal transmission and reception characteristics from the received digital broadcast signal (S300).

Next, the digital broadcast signal interface units 140 can receive a broadcast request signal requesting a specific broadcast signal from a digital broadcast signal indicator 400 in communication therewith (S320).

The digital broadcast signal(s) received by the digital signal interface unit(s) 140 is sent to the receiver CPU 120, and the receiver CPU 120 controls the digital broadcast signal interface units 140 receiving the requested broadcast signal, and externally transmits a demodulated and channel-decoding digital broadcast signal, and, at this time, the receiver CPU 120 transmits middleware that is a program to control the video processing, audio processing, and additional data processing in the digital broadcast signal indicator from which a broadcast signal free of transmission and reception characteristics is transmitted (S340).

The transmitted digital broadcast signal and the middleware are transmitted to the digital broadcast signal indicator that has transmitted the broadcast request signal through the Daisy chain bus constructed by use of the IEEE 1394 HSDI interface.

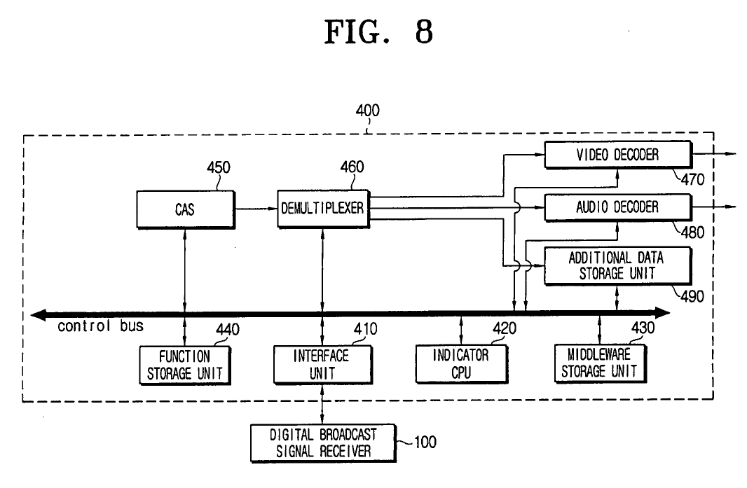

FIG. 7 is a flow chart explaining in detail the process of FIG. 6 of removing signal characteristics according to signal transmission and reception standards. Referring to FIG. 7, the digital broadcast signal receiver 100 tunes a channel for an external digital broadcast signal and receives the digital broadcast signal (S301). Further, the digital broadcast signal receiver 100 performs demodulation with respect to the digital broadcast signal according to the transmission and reception standard (S305), and performs channel decoding with respect to the demodulated digital broadcast signal to remove signal characteristics according to the transmission and reception standard (S307).

FIG. 8 is a block diagram illustrating in detail the digital broadcast signal indicator 400 of FIG. 2. Referring to FIG. 2, the present digital broadcast signal indicator 400 includes an interface unit 410, an indicator CPU 420, a middleware storage unit 430, a function storage unit 440, a CAS 450, a demultiplexer 460, a video decoder 470, an audio decoder 480, and an additional data storage unit 490.

It is possible to use the IEEE1394 HSDI interface for the interface unit 410, and the interface unit 410 provides interface to receive the demodulated and channel-decoded broadcast signal and middleware for processing a requested broadcast signal from the external digital broadcast signal receiver 100.

Here, the middleware for processing the requested broadcast signal is a program for descrambling, demultiplexing, video/audio decoding, and additional data processing in the present digital broadcast signal indicator 400, and the middleware is developed in the mobile programming language, preferably, in the JAVA programming language. Further, it is possible to develop the middleware by use of the broadcast signal processing API provided by a maker of the present digital broadcast signal indicator 400 in which functions for operations and operation controls in the present digital broadcast signal indicator are defined.

The middleware storage unit 430 stores the middleware received from the external digital broadcast signal receiver 100, and the function storage unit 440 stores functions provided in the API.

The indicator CPU 420 calls functions stored in the function storage unit 440 through a middleware interpreter, and runs the middleware stored in the middleware storage unit 440. In an aspect of the present general inventive concept, the digital broadcast signal indicator 400 further includes an interpreter storage unit(not shown) that stores the middleware interpreter, that is, a JAVA virtual machine in case that the middleware is developed in the JAVA programming language. Further, the indicator CPU 420 controls the CAS 450, demultiplexer 460, video decoder 470, audio decoder 480, and additional data storage unit 490 to process the received digital broadcast signal by use of the executed middleware.

As above, since the middleware corresponding to a received digital broadcast signal is received as the digital broadcast signal is received, a maker of the digital broadcast signal indicator can manufacture such products regardless of diverse standards applied to digital broadcast signals.

In the meantime, if a received digital broadcast signal is for a broadcast from a pay broadcast service, the CAS 450 descrambles the received digital broadcast signal corresponding to the scrambling manner with respect to the received digital broadcast signal, and restores a scrambling-free digital broadcast signal, and such restoration can be done with reading key values corresponding to the received digital broadcast signal from a card(not shown) built in the CAS 450. Therefore, the CAS 450 preferably has the card storing the key values corresponding to all scrambled digital broadcast signals that the digital broadcast signal receiver receives.

The demultiplexer 460 separates a signal restored by the CAS 450 or a non-scrambled signal into a video signal, audio signal, and additional data.

The video decoder 470 decodes the video signal under controls of the running middleware, and the video decoder 470 can be an MPEG video decoder. Further, the audio decoder 480 decodes the audio signal under controls of the running middleware, and the audio decoder 480 can be an MPEG audio decoder or a Dolby AC-3.

The separated additional data is stored in the additional data storage unit 490, and the indicator CPU 420 decodes the additional data and performs a certain process corresponding to the decoded additional data under controls of the running middleware.

The decoded video signal is displayed on an external display unit(not shown) through a video encoder (not shown), and the decoded audio signal is outputted as sounds through a digital/analog converter (not shown) and external speakers (not shown), and the digital broadcast signal indicator 400 may further include a video output display unit(not shown) and audio output speakers (not shown).

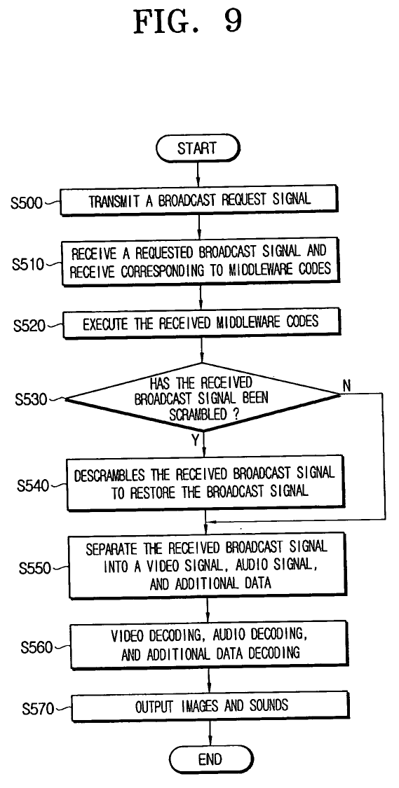

FIG. 9 is a flow chart explaining operations of the digital broadcast signal indicator of FIG. 8. Referring to FIG. 8 and FIG. 9, the digital broadcast signal indicator 400 transmits a broadcast request signal requesting a specific broadcast signal to be received according to a user's input (S500). In here, the broadcast request signal includes information on a device sending the broadcast request signal and information on a broadcast signal requested.

Based on the broadcast request signal sent in operation S500, the digital broadcast signal indicator 400 receives the requested broadcast signal and middleware for processing a broadcast signal requested by the digital broadcast signal indicator 400(S510), and runs the middleware (S520).

First, the digital broadcast signal indicator 400 checks if the received broadcast signal has been a scrambled broadcast signal (S530), and, if the received broadcast signal is not scrambled, separates the broadcast signal into a video signal, audio signal, and additional data (S550). If the received broadcast signal has been scrambled, the digital broadcast signal indicator 400 receives key values from a card corresponding to the requested broadcast signal, and descrambles the received broadcast signal (S550), wherein the card is one of at least one or more cards mounted in the CAS 150. Here, the descrambling is performed under controls of the middleware running in the operation S500.

If the descrambling is completed and a scrambling-free signal is restored, the digital broadcast signal indicator 400 separates the scrambling-free signal into a video signal, audio signal, and additional data signal (S560). The digital broadcast signal indicator 400 performs video-decoding, audio-decoding, and additional data processings with respect to the separated signals in operation S550, and outputs images and sounds (S570).

Since makers can manufacture such digital broadcast signal indicators regardless of different standards that respective service providers apply to their broadcast signals, and such digital broadcast signal indicators have a simplified internal structure, broadcast viewers can be equipped with such digital broadcast signal indicators at a low expense.

With the above method, the present digital broadcast signal processing system enables not only users to easily view diverse digital broadcasts at a low expense but also broadcast service providers to provide broadcast services at a low cost so that the providers can get more subscribers.

As described above, the system constructed according to the present general inventive concept enables users to remove investment in the identical devices for the system, so that the users can be provided with multiple broadcast services at a low expense, and, further, the system facilitates its expansion to more digital broadcast signals since the digital broadcast signals can be more widely received only with simple connections of digital broadcast signal interface units for broadcast signals that users want to receive. Further, the system has an effect of reducing the users' expense due to overcoming the conventional limitation to locations in receiving broadcast signals.

In the meantime, the broadcast service providers can reduce the broadcast service cost since they have only to provide the digital broadcast signal interface units as devices with which they have to provide their subscribers to receive the broadcast services they offer, to thereby collect more subscribers.

Further, the makers of the digital broadcast signal receivers and the digital broadcast signal indicators can reduce the cost caused by the processing of the broadcast signals characterized in compliance with standards.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A digital broadcast signal processing system, comprising:
a digital broadcast signal receiver that receives at least one digital broadcastsignal, removes signal characteristics according to standards for transmission and reception of the at least one digital broadcast signal, receives a broadcast request signal, and transmits a digital broadcast signal from which the signal characteristics according to a transmission and reception standard have been removed corresponding to the broadcast request signal and middleware for processing the digital broadcast signal from which the signal characteristics according to the corresponding transmission and reception standard have been removed, and
at least one digital broadcast signal indicator that transmits the broadcast request signal inputted by a user to the digital broadcast signal receiver, receives from the digital broadcast signal receiver the middleware and the digital broadcast signal from which the signal characteristics according to the transmission and reception standard have been removed, and processes the digital broadcast signal according to the middleware.

2. The digital broadcast signal processing system as claimed in claim 1, wherein the digital broadcast signal receiver includes:
unit connectors that detachably connect digital broadcast signal interface units that receive the digital broadcast signals and remove the signal characteristics according to the signal transmission and reception standard with respect to the received digital broadcast signals;
a memory that stores the middleware corresponding to the received digital broadcast signals; and
a receiver central processing unit (CPU) that controls the transmission of the middleware and the digital broadcast signal from which the signal characteristics according to the signal transmission and reception standard have been removed to the digital broadcast signal indicator.

3. The digital broadcast signal processing system as claimed in claim 2, wherein the digital broadcast signal interface units each include:
a tuner that tunes a channel and receives the digital broadcast signal;
a channel decoder that performs demodulation and channel decoding with respect to the received digital broadcast signal according to a signal transmission and reception standard for the received digital broadcast signal, and removes the signal characteristics according to the signal transmission and reception standard; and
a unit interface that receives the digital request signal from the digital broadcast signal indicator, and provides the digital broadcast signal indicator with the middleware and the digital broadcast signal from which the signal characteristics according to the signal transmission and reception standard have been removed by the controls of the receiver CPU.

4. The digital broadcast signal processing system as claimed in claim 1, wherein the digital broadcast signal indicator includes:
an interface unit that receives the middleware and the digital broadcast signal from which the signal characteristics according to the signal transmission and reception standard have been removed;
a demultiplexer that separates the received digital broadcast signal into a video signal, audio signal, and additional data;
one or more decoders that decode the separated video signal and audio signal; and
an indicator CPU that controls the demultiplexer and the decoders according to the received middleware.

5. The digital broadcast signal processing system as claimed in claim 4, wherein the indicator CPU processes the additional data according to the received middleware and adds the processed additional data to the video signal.

6. The digital broadcast signal processing system as claimed in claim 4, further comprising a conditional access system (CAS) that descrambles the digital broadcast signal corresponding to a scrambling manner for the digital broadcast signal, wherein the CAS operates according to the middleware.

7. The digital broadcast signal processing system as claimed in claim 4, further comprising a function storage unit that stores functions corresponding to the middleware developed by use of a broadcast signal processing Application Programming Interface (API) which consists of a set of functions that define operations and control the defined operations for processing the digital broadcast signal in the digital broadcast signal indicator.

8. The digital broadcast signal processing system as claimed in claim 1, wherein the digital broadcast signal receiver and the digital broadcast signal indicator constitute a Daisy chain network by use of an IEEE1394 High Speed Data Interface (HSDI).

9. The digital broadcast signal processing system as claimed in claim 1, wherein the digital broadcast signal is any of a ground wave digital broadcast signal, satellite digital broadcast signal, and cable digital broadcast signal.

10. A digital broadcast signal processing method, comprising:
a digital broadcast signal receiving operation of receiving at least one digital broadcast signal, removing signal characteristics according to standards for transmission and reception of the digital broadcast signals, receiving a broadcast request signal, and transmitting a digital broadcast signal from which the signal characteristics according to a signal transmission and reception standard have been removed corresponding to the broadcast request signal and middleware for processing the digital broadcast signal from which the signal characteristics according to the corresponding signal transmission and reception standard have been removed, and
a digital broadcast signal indicating operation of transmitting the broadcast request signal inputted by a user, receiving the middleware and the digital broadcast signal from which the signal characteristics according to the signal transmission and reception standard have been removed, and processing the digital broadcast signal according to the middleware.

11. The digital broadcast signal processing method as claimed in claim 10, wherein the digital broadcast signal receiving operation includes:
a digital broadcast signal interfacing operation of receiving at least one or more digital broadcast signals and removing the signal characteristics according to the signal transmission and reception standard with respect to the received digital broadcast signals;
an operation of receiving the broadcast request signal; and
an operation of transmitting the middleware and the digital broadcast signal corresponding to the broadcast request signal from which the signal characteristics according to the signal transmission and reception standard have been removed.

12. The digital broadcast signal processing method as claimed in claim 11, wherein the digital broadcast signal interfacing operation includes:
a tuning operation of tuning a channel and receiving the digital broadcast signal;
a channel decoding operation of performing demodulation and channel decoding with respect to the received digital broadcast signal according to a signal transmission and reception standard for the received digital broadcast signal, and removing the signal characteristics according to the signal transmission and reception standard; and
a unit interfacing operation of providing an external device with the middleware and the digital broadcast signal from which the signal characteristics according to the signal transmission and reception standard have been removed corresponding to the reception of the broadcast request signal.

13. The digital broadcast signal processing method as claimed in claim 10, wherein the digital broadcast signal indicating operation includes:
an interfacing operation of receiving the middleware and the digital broadcast signal from which the signal characteristics according to the signal transmission and reception standard have been removed;
a demultiplexing operation of separating the received digital broadcast signal into a video signal, audio signal, and additional data according to the received middleware; and
a decoding operation of decoding the separated video signal and audio signal according to the received middleware.

14. The digital broadcast signal processing method as claimed in claim 13, further comprising a conditional access system (CAS) operation of descrambling the digital broadcast signal corresponding to a scrambling manner for the digital broadcast signal, wherein the CAS operation operates according to the middleware.

15. The digital broadcast signal processing method as claimed in claim 13, further comprising a function storage operation of storing functions provided in an Application Program Interface (API) corresponding to the middleware developed by use of a broadcast signal processing API which consists of a set of functions that define operations and control the defined operations for processing the digital broadcast signal.

16. The digital broadcast signal processing method as claimed in claim 10, wherein the digital broadcast signal is any of a ground wave digital broadcast signal, satellite digital broadcast signal, and cable digital broadcast signal.

17. A digital broadcast signal processing system, comprising:
unit connectors that detachably connect digital broadcast signal interface units that receive digital broadcast signals and remove the signal characteristics according to the signal transmission and reception standard with respect to the received digital broadcast signals;
a memory that stores middleware for processing the digital broadcast signals from which the signal characteristics according to the signal transmission and reception standard have been removed; and
a receiver CPU that controls the transmission of the middleware and the digital broadcast signal from which the signal characteristics acccording to the signal transmission and reception standard have been removed to a digital broadcast signal indicator.

18. The digital broadcast signal processing system as claimed in claim 17, wherein the digital broadcast signal interface units each include:
a tuner that tunes a channel and receives a digital broadcast signal;
a channel decoder that performs demodulation and channel decoding with respect to the received digital broadcast signal according to a signal transmission and reception standard for the received digital broadcast signal, and removes the signal characteristics according to the signal transmission and reception standard; and
a unit interface that receives a digital request signal from the digital broadcast signal indicator, and provides an external device with the middleware and the digital broadcast signal from which the signal characteristics according to the signal transmission and reception standard have been removed by the controls of the receiver CPU.

19. The digital broadcast signal processing system as claimed in claim 17, wherein the middleware is developed in the JAVA programming language.

20. The digital broadcast signal processing system as claimed in claim 17, further comprising a conditional access system (CAS) that descrambles the digital broadcast signal corresponding to a scrambling manner of the digital broadcast signal.

21. The digital broadcast signal processing system as claimed in claim 17, wherein the digital broadcast signal is any of a ground wave digital broadcast signal, satellite digital broadcast signal, and cable digital broadcast signal.

22. A digital broadcast signal indicator, comprising:
an interface unit that receives a digital broadcast signal from which the signal characteristics according to the signal transmission and reception standard have been removed and middleware for processing the digital broadcast signal from which the signal characteristics according to the signal transmission and reception standard have been removed;
a demultiplexer that separates the received digital broadcast signal into a video signal, audio signal, and additional data;
one or more decoders that decode the separated video signal and audio signal; and
an indicator CPU that controls the demultiplexer and the decoders according to the received middleware.

23. The digital broadcast signal indicator as claimed in claim 22, wherein the digital broadcast signal from which the signal characteristics according to the signal transmission and reception standard have been removed is a digital broadcast signal demodulated and channel-decoded corresponding to channel coding and modulation manners according to the signal transmission and reception standard applied to the digital broadcast signal.

24. The digital broadcast signal indicator as claimed in claim 22, further comprising a conditional access system (CAS) that descrambles the digital broadcast signal corresponding to a scrambling manner of the digital broadcast signal, wherein the CAS operates according to the middleware.

25. The digital broadcast signal indicator as claimed in claim 22, further comprising a function storage unit that stores functions corresponding to the middleware developed by use of a broadcast signal processing Application Programming Interface (API) which consists of a set of functions that define operations and control the defined operations for processing the digital broadcast signal in the digital broadcast signal indicator.

26. The digital broadcast signal indicator as claimed in claim 22, wherein the indicator CPU processes additional data according to the middleware and adds the processed additional data to the video signal.

27. The digital broadcast signal indicator as claimed in claim 22, wherein the digital broadcast signal is any of a ground wave digital broadcast signal, satellite digital broadcast signal, and cable digital broadcast signal.

28. A digital broadcast signal indicating method, comprising:
receiving a digital broadcast signal from which signal characteristics according to the signal transmission and reception standard for the digital broadcast signal have been removed and middleware for processing the digital broadcast signal from which the signal characteristics according to the signal transmission and reception standard have been removed;
separating the received digital broadcast signal into a video signal, audio signal, and additional data according to the middleware; and
decoding the separated video signal and audio signal according to the middleware.

29. The digital broadcast signal indicating method as claimed in claim 28, wherein the digital broadcast signal from which the signal characteristics according to the signal transmission and reception standard have been removed is a digital broadcast signal demodulated and channel-decoded corresponding to channel coding and modulation manners according to the signal transmission and reception standard applied to the digital broadcast signal.

30. The digital broadcast signal indicating method as claimed in claim 28, further comprising a conditional access system (CAS) operation of descrambling the digital broadcast signal corresponding to a scrambling manner for the digital broadcast signal, wherein the CAS operates according to the middleware.

31. The digital broadcast signal indicating method as claimed in claim 28, further comprising a function storage operation of storing functions corresponding to the middleware developed by use of a broadcast signal processing Application Programming Interface (API) which consists of a set of functions that define operations and control the defined operations for processing the digital broadcast signal in the digital broadcast signal indicating method.

32. The digital broadcast signal indicating method as claimed in claim 28, further comprising an operation of processing additional data according to the middleware and adding the processed additional data to the video signal.

33. The digital broadcast signal indicating method as claimed in claim 28, wherein the digital broadcast signal is any of a ground wave digital broadcast signal, satellite digital broadcast signal, and cable digital broadcast signal.

34. A digital broadcast signal interface unit, comprising:
a tuner that tunes a channel and receives a digital broadcast signal;
a channel decoder that removes signal characteristics according to a signal transmission and reception standard with respect to the received digital broadcast signal; and
a unit interface that provides an external device with the digital broadcast signal from which the signal characteristics according to the signal transmission and reception standard have been removed.

35. The digital broadcast signal interface unit as claimed in claim 34, wherein the signal characteristics according to the signal transmission and reception standard have been removed by use of demodulation and channel-decoding corresponding to channel coding and modulation manners according to the signal transmission and reception standard applied to the digital broadcast signal.

36. The digital broadcast signal interface unit as claimed in claim 34, further comprising a memory that stores middleware that is a program for processing the digital broadcast signal from which signal characteristics according to a signal transmission and reception standard have been removed.

37. A computer readable storage medium including a digital broadcast signal indicating method, the method comprising:
receiving a digital broadcast signal from which signal characteristics according to the signal transmission and reception standard for the digital broadcast signal have been removed and middleware for processing the digital broadcast signal from which the signal characteristics according to the signal transmission and reception standard have been removed;
demodulating the received digital broadcast signal into a video signal, audio signal, and additional data according to the middleware; and
decoding the separated video signal and audio signal according to the middleware.

38. The computer readable storage medium of claim 37, wherein the digital broadcast signal from which the signal characteristics according to the signal transmission and reception standard have been removed is a digital broadcast signal demodulated and channel-decoded corresponding to channel coding and modulation manners according to -the signal transmission and reception standard applied to the digital broadcast signal.

39. The computer readable storage medium of claim 37, wherein the method further comprises:
a conditional access system (CAS) operation of descrambling the digital broadcast signal corresponding to a scrambling manner for the digital broadcast signal, wherein the CAS operates according to the middleware.

40. The computer readable storage medium of claim 37, wherein the method further comprises:
a function storage operation of storing functions corresponding to the middleware developed by use of a broadcast signal processing Application Programming Interface (API) which consists of a set of functions that define operations and control the defined operations for processing the digital broadcast signal in the digital broadcast signal indicating method.

41. The computer readable storage medium of claim 37, further comprising an operation of processing additional data according to the middleware and adding the processed additional data to the video signal.

42. The computer readable storage medium of claim 37, wherein the digital broadcast signal is any of a ground wave digital broadcast signal, satellite digital broadcast signal, and cable digital broadcast signal.
